(19) United States
(12) Patent Application Publication
(10) Pub. No.: US 2015/0117589 A1
(43) Pub. Date: Apr. 30, 2015

(54) Molten Salt Reactor

(71) Applicant: Takashi KAMEI, Kyoto (JP)

(72) Inventors: Takashi Kamei, Kyoto (JP); Atsuhiko Hirai, Kyoto (JP)

(21) Appl. No.: 14/404,611

(22) PCT Filed: May 24, 2013
(86) PCT No.: PCT/JP2013/064475

§ 371 Date: Nov. 29, 2014

(30) Foreign Application Priority Data
May 30, 2012 (JP) 2012-122679

(51) Int. Cl. G21C 1/22; G21C 15/243

(52) U.S. Cl. CPC G21C 1/22; G21C 15/243
USPC 376/347

(57) ABSTRACT

To provide a molten salt reactor that enables heat in the molten salt reactor to be extracted without bringing metal piping for heat exchange into direct contact with a molten salt. A molten salt reactor is provided with: a moderator structure 3 which has at least one molten salt flow path 2 vertically passing therethrough, a reflector 4 which is disposed above, below and around the moderator structure with a molten salt circulation gap X therebetween, a reactor vessel 5 which houses the reflector 4, and a coolant flow path 10A through which a coolant that exchanges heat with the interior of the reactor vessel 5 through a wall of the reactor vessel 5 flows.

### TECHNICAL FIELD

The present invention relates to a molten salt reactor.

### BACKGROUND ART

A molten salt reactor is a liquid fuel reactor that uses a nuclear fuel material (uranium, thorium etc.) by dissolving the material in a molten salt for preparing a liquid fuel and utilizes heat generated in the reactor for purposes such as power generation. A fluoride molten salt (LiF—BeF₂) is considered as a most suitable molten salt to be used as a solvent for the fuel. The liquid fuel is prepared by dissolving a fertile material, ThF₄ and a fissionable material, ²³³UF₄ in the fluoride molten salt.

Small molten salt reactors invented by Furukawa et al. (Patent Document 1, 2 etc.) and a small molten salt reactor invented by Nishibori et al. (Patent Document 3) etc. are known as molten salt reactors of this type.

### RELATED ART DOCUMENTS

### Patent Documents

Patent Document 1: Japanese Unexamined Patent Application Publication No. S62-130384.

Patent Document 2: Japanese Unexamined Patent Application Publication No. H07-91171.

Patent Document 3: Japanese Unexamined Patent Application Publication No. S57-1991.

### SUMMARY OF INVENTION

### Problems to be Solved by the Invention

However, in molten salt reactors disclosed in Patent documents 1 and 2, a molten salt that contains a nuclear fuel material is sent to outside of a reactor core through primary system piping which includes thin-metal piping for heat exchange. As a result, there have been problems including: i) increase of radiation dose in an outer reactor core space, ii) radioactivation of the primary system piping, iii) corrosion of the primary system piping, iv) transfer of tritium to a secondary system, v) leakage and loss of delayed neutrons, and vi) increase of nuclear fuel material inventory outside of the reactor core.

In a molten salt reactor disclosed in Patent document 3, because piping for heat exchange is located inside of a reactor vessel, it is considered that there are also problems including: i) corrosion and embrittlement due to neutron irradiation of the piping of the heat exchanger (secondary system piping) provided in the reactor vessel, ii) transfer of tritium to the secondary system, and iii) leakage of delayed neutrons from a molten salt that flows in a region of the heat exchanger to outside of the reactor vessel.

### Means of Solving the Problems

A main object of the present invention is to provide a molten salt reactor that enables heat in the reactor to be extracted without bringing metal piping for heat exchange into direct contact with a molten salt to solve the above problems.

To achieve the object, the molten salt reactor according to the present invention includes a moderator structure which has at least one molten salt flow path vertically passing therethrough, a reflector which is disposed above, below and around the moderator structure with a molten salt circulation gap therebetween, a reactor vessel which houses the reflector, and a coolant flow path through which a coolant that exchanges heat with the interior of the reactor vessel through a wall of the reactor vessel flows.

In one embodiment, the coolant flow path is formed by a heat exchanging shell that houses the reactor vessel.

In another embodiment, a drain tank that is connected to the reactor vessel and housed in the heat exchanging shell is further provided.

In still another embodiment, the coolant flow path is formed by a jacket that surrounds an outer peripheral face of the reactor vessel.

In still yet another embodiment, the coolant flow path is formed by a pipe that is wound around the outer peripheral face of the vessel wall.

In yet another embodiment, a vent hole formed on the reflector for releasing a gaseous fission product and an absorbent chamber that houses an absorbent which absorbs the gaseous fission product released from the vent hole are further provided.

In still another embodiment, a heat dissipating fin formed on the outer peripheral face of the reactor vessel is further provided.

In still yet another embodiment, a circulation device is further provided for promoting a circulating flow of the molten salt that flows from a lower part and comes out from an upper part of the molten salt flow path, and subsequently flows down in the molten salt circulation gap, and then flows into the lower part of the molten salt flow path again.

In another embodiment, the reflector is made of graphite or SiC.

In yet another embodiment, an external reflector for changing a rate of neutron leakage from inside of the reactor vessel is further provided on the outer periphery of the reactor vessel.

In another embodiment, the external reflector is provided so as to be movable in a vertical direction.

In still another embodiment, the external reflector is supported by a coupling device that is uncoupled by power shutdown.

### Effects of the Invention

In a molten salt reactor according to the present invention, a molten salt that is heated by nuclear fission radiates heat to outside through a wall of a reactor vessel while flowing from an upper part to a lower part of a molten salt circulation gap, and subsequently flowing into a molten salt flow path in a moderator structure from a bottom part of the moderator structure, and then flowing upwardly through the molten salt flow path by natural convection to generate a circulating flow by natural circulation. A flow rate of the circulating flow can be increased and controlled by adding a circulation device.

The heat from the molten salt in the reactor vessel which is generated by nuclear fission may be extracted by being transferred to a coolant through the wall of the reactor vessel.

A high-safety molten salt reactor may be provided without problems such as radioactivation and corrosion of piping, transfer of tritium and leakage of delayed neutrons because a reflector is disposed above, below and around the molten salt without bringing the piping for heat exchange into contact with the molten salt.

### BRIEF DESCRIPTION OF DRAWINGS

FIG. 1 is a longitudinal sectional view of an embodiment of a molten salt reactor according to the present invention;

FIG. 2 is a cross-sectional view of the molten salt reactor taken along the line II-II of FIG. 1;

FIG. 3 is a cross-sectional view of the molten salt reactor of FIG. 1 in operation;

FIG. 4 is a longitudinal sectional view of another embodiment of the molten salt reactor according to the present invention; and

FIG. 5 is a longitudinal sectional view of yet another embodiment of the molten salt reactor according to the present invention.

### MODE(S) FOR CARRYING OUT THE INVENTION

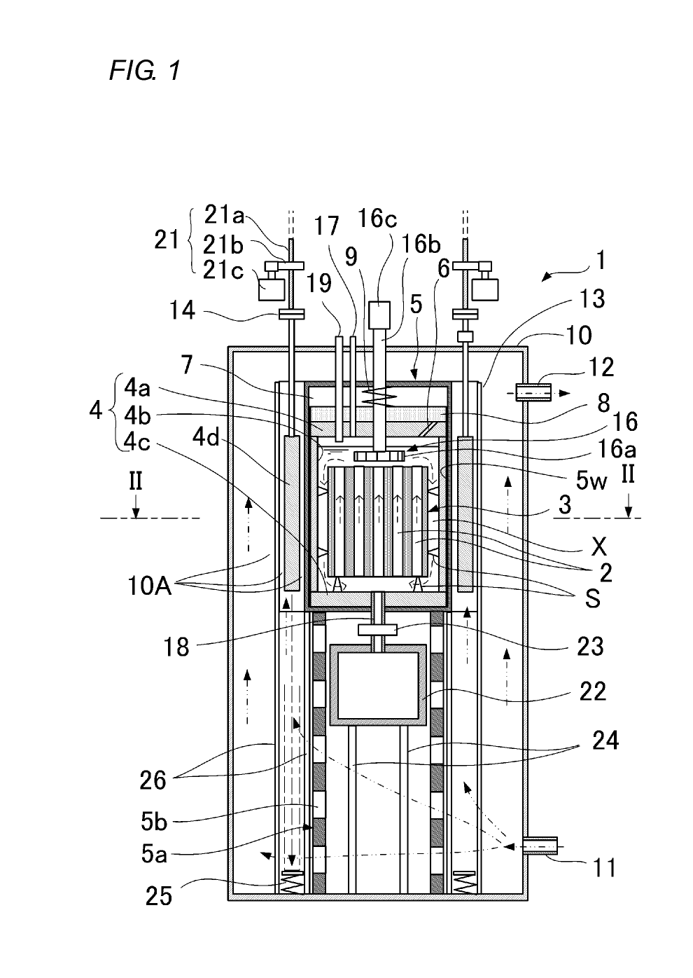

Hereinafter, referring to drawings FIG. 1 to FIG. 5, embodiments of a molten salt reactor according to the present invention will be explained. Same reference numerals are used for referring to same or similar components in all the drawings and embodiments in order to avoid repeating same explanations.

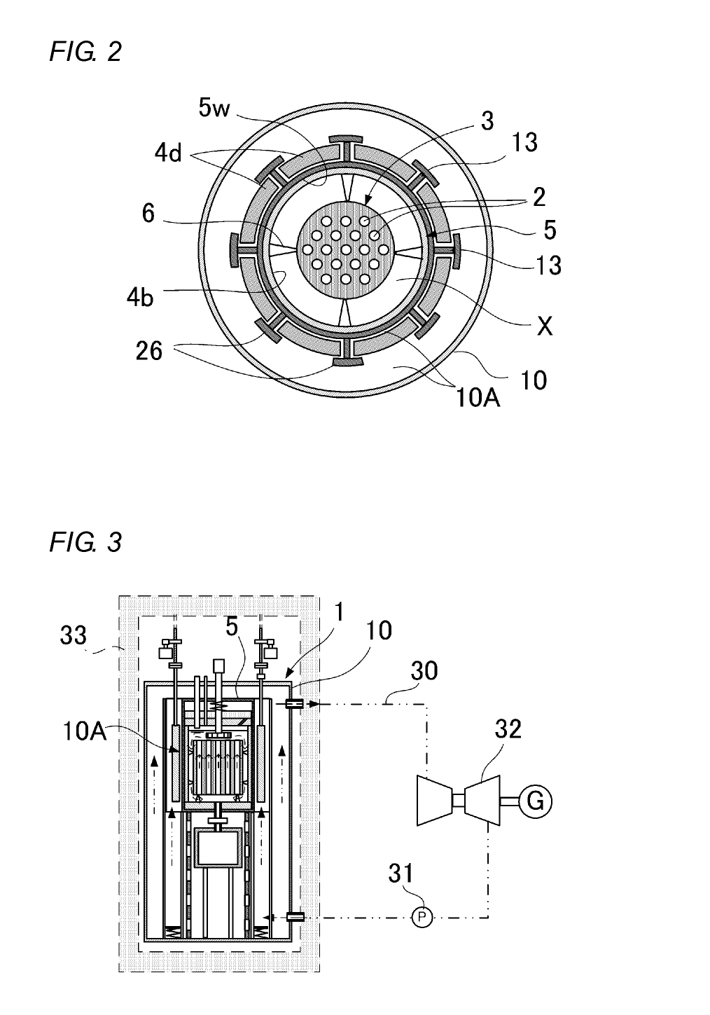

As shown in FIG. 1 and FIG. 2, the molten salt reactor 1 includes a moderator structure 3 which has at least one molten salt flow path 2 vertically passing therethrough, a reflector 4 which is disposed above, below and around the moderator structure 3 with a molten salt circulation gap X therebetween, a reactor vessel 5 which houses the reflector 4 and a coolant flow path 10A through which a coolant that exchanges heat with the interior of the reactor vessel 5 through a wall 5w of the reactor vessel 5 flows. A reactor core is formed by the moderator structure 3 and a molten salt. The reflector 4 surrounds the reactor core. In FIG. 1, a dotted line arrow indicates a flow of the molten salt and a chain double-dashed line arrow indicates a flow of the coolant.

The moderator structure 3 can be made of materials like graphite or SiC. The reflector 4 serves to prevent neutrons from escaping to outside and to scatter neutrons which is leaking out of the reactor core to return them to the reactor core again. Therefore, the reflector 4 can be made of materials like graphite or SiC. SiC can be preferably used for the reflector 4 for its thermal conductivity. The reactor vessel 5 can be made of a corrosion-resistant material such as Ni based alloy and preferably made of Hastelloy N or MONICR.

A spacer S is disposed between the moderator structure 3 and the reflector 4 for forming the molten salt circulation gap X.

The reflector 4 has an upper wall 4a, a peripheral wall 4b and a bottom wall 4c. In an example shown, each of the upper wall 4a, the peripheral wall 4b and the bottom wall 4c has a block structure and forms a space that houses the moderator structure 3 and the molten salt by being placed one on top of another. Preferably, the reflector 4 is provided to fit on an interior wall of the reactor vessel 5 closely. The reflector 4 may be also furnished by lining the interior wall of the reactor vessel 5 with the material of the reflector such as graphite or SiC.

A vent hole 6 for releasing a gaseous fission product that is produced by a nuclear fission reaction is formed on the upper wall 4a of the reflector 4. The gaseous fission product released from the vent hole 6 enters to an absorbent chamber 7 that is provided on top of the upper wall 4a and is absorbed by an absorbent 8 that is housed in the absorbent chamber 7. For instance, a formed port coal may be used as the absorbent 8. A spring 9 is disposed between a ceiling part of the absorbent chamber 7 and the absorbent 8 and absorbs expansion of the reflector 4 due to swelling etc. Neutrons may be prevented from passing through the upper wall 4a by forming the vent hall 6 in a slanting direction.

The reactor vessel 5 is housed in a heat exchanging shell 10. The reactor vessel 5 is supported in the heat exchanging shell 10 and is supported with a cylindrical supporting leg 5a in the heat exchanging shell 10 in the example shown in FIG. 1. A coolant hole 5b through which the coolant flows is formed on the supporting leg 5a. The heat exchanging shell 10 has an inlet 11 and an outlet 12 of the coolant. For instance, a circulating flow path 30 as shown in FIG. 3 is connected to the inlet 11 and the outlet 12 of the heat exchanging shell 10, and the coolant is circulated by a pump 31 which is disposed in the circulating flow path 30. A helium gas turbine 32 is provided in the circulating flow path 30 as a heat engine in the example shown. In this case, the coolant flow path 10A is formed on an outer peripheral face of the reactor vessel 5 in the heat exchanging shell 10. As the coolant, for example, nitrogen gas, carbonic acid gas or helium gas can be used. There also can be provided a concrete-made biological shield 33 for preventing radiation leakage from the reactor core as shown in FIG. 3.

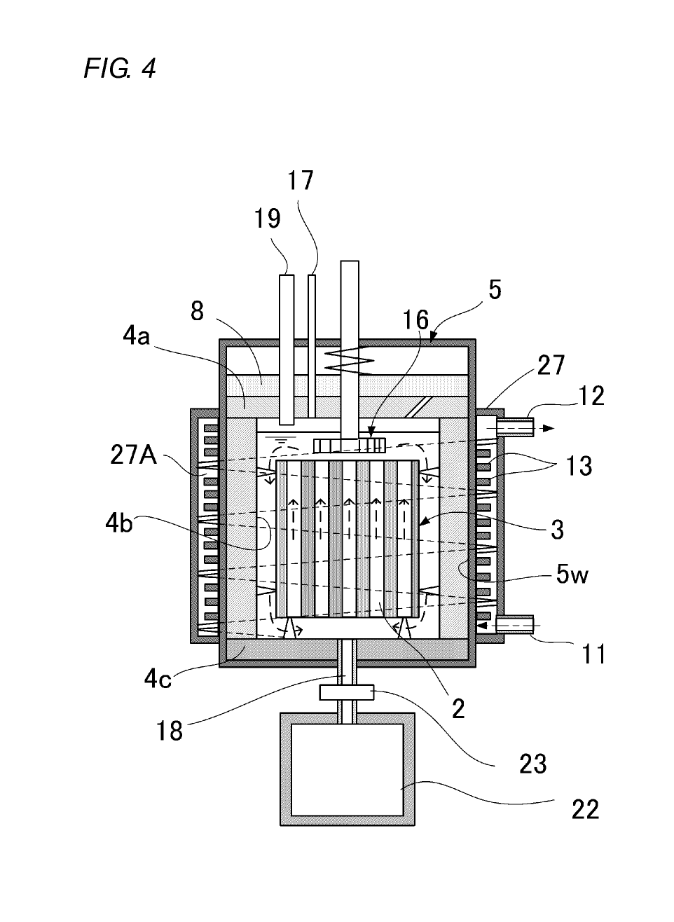

A heat dissipating fin 13 is integrally formed with the outer-periphery wall surface of the reactor vessel 5. The heat dissipating fin 13 vertically extends and a plurality of the fins is radially provided at intervals of equal angle in the example shown in FIG. 1 and FIG. 2. The heat dissipating fin 13 may be extended horizontally (Refer to FIG. 4).

An external reflector 4d for changing or adjusting a rate of neutron leakage from inside of the reactor vessel is provided along the outer peripheral face of the reactor vessel 5. In the example shown, the external reflector 4d is disposed between the two adjacent heat dissipating fins 13 that are provided at intervals of equal angle. A gap through which the coolant flows is formed between an inner surface of the external reflector 4d and the outer peripheral face of the reactor vessel 5 and the gap can partially form the coolant flow path 10A.

The external reflector 4d is made of graphite or SiC and prevents the heat exchanging shell 10 from radioactivation while increasing neutron utilization efficiency by reflecting neutrons emitted to outside of the reactor vessel 5 toward inside of the reactor vessel 5.

The external reflector 4d may be supported along the outer peripheral face of the reactor vessel 5 with an emergency coupling device 14 that is uncoupled by power shutdown. The coupling device 14 drops the external reflector 4d when magnetic force is lost by a reason such as loss of outside power source to an electromagnet in an accident. The reactor may be promptly shut down by being shifted to a subcritical state due to a higher neutron leakage rate which is increased by falling of the external reflector 4d. The emergency coupling device 14 is not limited to the device with an electromagnet as a means for coupling and other means may be used as long as the device is uncoupled by power shutdown. While not shown in the drawings, for example, the coupling device may be configured to have a hook that is activated by operation of an oil hydraulic cylinder to engage with the external reflector and is released to drop the external reflector by suspension of hydraulic pressure supply to the oil hydraulic cylinder due to shutdown of a hydraulic pump due to loss of power source.

The external reflector 4d may also be used for output adjustment by being connected to a drive unit 21 and driven in a vertical direction. As shown in the example, the drive unit 21 may be configured to have a ball screw 21a, a ball screw nut 21b and a motor 21c that rotates the ball screw nut 21b etc., or another known drive unit such as an electric winch that winds a wire with which the external reflector 4d is suspended.

A circulation device 16 may be additionally provided for promoting a circulating flow of the molten salt that flows from a lower part and comes out from an upper part of the molten salt flow path 2, and subsequently flows down in the molten salt circulation gap X, and then flows into the lower part of the molten salt flow path 2 again.

The circulation device 16 shown in the example has a centrifugal blade 16a that is distributed on top of the moderator structure 3. A drive shaft 16b that is connected to the centrifugal blade 16a extends upward passing through the reactor vessel 5 and the heat exchanging shell 10, and the drive shaft 16b is connected to a motor 16c. The circulation device 16 is not limited to the one shown in the example and other means such as a screw or a pump that forces to generate a circulating flow may be used.

A fuel supply port 17 for supplying fuel and a drain pipe 18 for draining fuel are provided to the reactor vessel 5 and a control rod 19 is supported so as to be movable vertically. A drain tank 22 is connected to a lower end of the drain pipe 18. The drain tank 22 may be made of a same material with the reactor vessel 5. There is a freeze valve (solidification valve) 23 disposed in the drain pipe 18. The control rod 19 can be made of B₄C (Boron Carbide). The drive shaft 16b of the circulation device 16 may be formed as a hollow pipe and the control rod 19 may be housed in the hollow.

When the molten salt reactor is in operation, the freeze valve 23 is put in a closed state by solidifying the molten salt inside of the freeze valve by maintaining its temperature at a solidifying point or below (for example, at 450° C. or below) by being cooled from its periphery with a cooling means such as the coolant or an electric fan. In case the molten salt reactor loses power source due to some trouble etc, the freeze valve 23 loses the cooling means and the molten salt inside of the freeze valve melts to open the valve, then the hot molten salt is drained out to the drain tank 22. The molten salt drained to the drain tank 22 has decay heat which needs to be removed and the drain tank 22 may be cooled by the coolant that circulates in the heat exchanging shell 10 by being housed in the heat exchanging shell 10. Therefore, the heat exchanging shell 10 serves to shield radiation emitted from the molten salt inside of the drain tank 22 and store the radioactive material.

A supporting mechanism 24 is provided to an inner bottom of the heat exchanging shell 10 and the drain tank 22 is supported with the supporting mechanism 24 so as to be kept up from the bottom of the heat exchanging shell 10. This is to avoid a criticality accident which can happen if the dropped external reflector 4d is situated next to the drain tank 22 when the molten salt is discharged from the reactor vessel 5 to the drain tank 22 and then neutrons emitted from the molten salt stored in the drain tank 22 are reflected by the external reactor 4d.

There is a buffer material 25 provided to the bottom of the heat exchanging shell 10 so that the external reflector 4d does not break when dropped. There is also a guiding rail 26 provided that vertically guides internal and external surfaces of four corners of the external reflector 4d not to let the external reflector 4d to shake in the coolant flow when driven up and down or to fall down when dropped.

In the molten salt reactor 1 with the above described configuration, the nuclear fuel material that is dissolved in the molten salt generates a reaction of nuclear fission inside of the molten salt flow path 2 of the moderator structure 3 and moves upward in the molten salt flow path 2 as heated. The molten salt that has moved upward in the molten salt flow path 2 and flowed out from the molten salt flow path 2 then flows into the molten salt circulation gap X. In the molten salt circulation gap X, the heat of the molten salt is transferred to the coolant that flows around the reactor vessel 5 through the reflector 4 and the wall of the reactor vessel 5 (heat transfer wall). The molten salt the heat of which has been removed in the molten salt circulation gap X flows into a lower part of the moderator structure 3 then flows into the molten salt flow path 2 again. This is how the circulating flow is generated by natural convection. The circulation device 16 accelerates the circulating flow generated by natural convection and also controls a flow rate of the circulating flow. The reflector 4 reflects delayed neutrons emitted from the molten salt toward inside of the reactor vessel 5. Because a gaseous fission product that is produced in a nuclear fission reaction is absorbed and retained in the absorbent 8 in the absorbent chamber 7, absorption of neutrons by the gaseous fission product that stagnates in the reactor may be avoided and accordingly neutron utilization efficiency may be increased while amount of the gaseous fission product released into the environment in case the reactor vessel is damaged may be kept to a minimum.

In the molten salt reactor 1, as is evident from the above, radioactivation or corrosion of piping for heat exchange etc. does not occur because the molten salt is circulated inside of a space which is surrounded by the reflector 4 in the reactor vessel 5 and not brought out from the reactor vessel 5 through the piping, and also there are not any piping for heat exchange etc. inside of the reactor vessel 5. Reaction efficiency may be enhanced because delayed neutrons are reflected toward inside of the reactor vessel 5 by the reflector 4 and they can contribute to nuclear fission.

FIG. 4 is a cross-sectional view of another embodiment of the molten salt reactor according to the present invention. In this embodiment, a coolant flow path 27A is formed by a jacket 27 that circulates the coolant on the outer periphery of the reactor vessel 5 and heat that is generated in the reactor vessel 5 is transferred to the coolant that flows in the coolant flow path 27A of the jacket 27 through the wall 5w of the reactor vessel 5. The coolant flow path 27A of the jacket 27 may be formed as a spiral flow path that allows the coolant to flow spirally on the outer periphery of the reactor vessel 5.

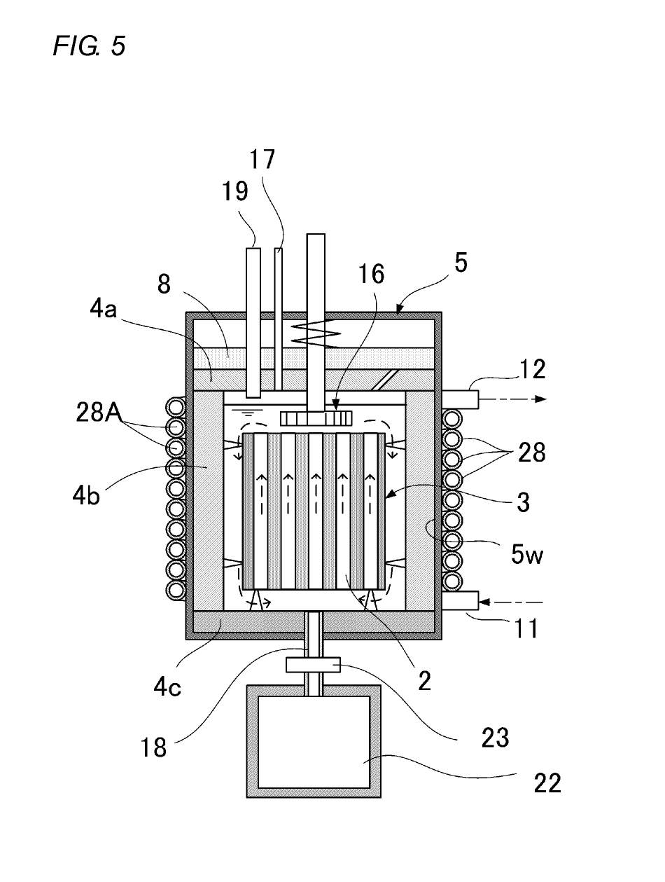

FIG. 5 is a cross-sectional view of another embodiment of the molten salt reactor according to the present invention. In this embodiment, a coolant flow path 28A is formed by a pipe 28 that circulates the coolant on the outer periphery of the reactor vessel 5 and heat that is generated in the reactor vessel 5 is transferred to the coolant that flows in the coolant flow path 28A of the pipe 28 through the wall 5w of the reactor vessel 5. The coolant flow path 28A of the pipe 28 may be formed as a spiral flow path that allows the coolant to flow spirally on the outer periphery of the reactor vessel 5.

The present invention is not interpreted only as the above limited embodiments and various changes may be made without departing from the scope of the invention.

### DESCRIPTION OF REFERENCE MARKS

1: Molten salt reactor

2: Molten salt flow path

3: Moderator structure

4: Reflector

4a: Upper wall

4b: Peripheral wall

4c: Bottom wall

4d: External reflector

5: Reactor vessel

7: Absorbent chamber

8: Absorbent

10: Heat exchanging shell

10A, 27A, 28A: Coolant flow path

13: Heat dissipating fin

16: Circulation device

1. A molten salt reactor comprising:
a moderator structure which has at least one molten salt flow path vertically passing therethrough;
a reflector which is disposed above, below and around the moderator structure with a molten salt circulation gap therebetween;
a reactor vessel which houses the reflector; and
a coolant flow path through which a coolant that exchanges heat with the interior of the reactor vessel through a wall of the reactor vessel flows.

2. The molten salt reactor according to claim 1, wherein the coolant flow path is formed by a heat exchanging shell that houses the reactor vessel.

3. The molten salt reactor according to claim 2, wherein the molten salt reactor is connected to the reactor vessel and further comprises a drain tank that is housed in the heat exchanging shell.

4. The molten salt reactor according to claim 1, wherein the coolant flow path is formed by a jacket that surrounds an outer peripheral face of the reactor vessel.

5. The molten salt reactor according to claim 1, wherein the coolant flow path is formed by a pipe that is wound around the outer peripheral face of the vessel wall.

6. The molten salt reactor according to claim 1, wherein the molten salt reactor further comprises a vent hole that is formed on the reflector for releasing a gaseous fission product and an absorbent chamber that houses an absorbent which absorbs the gaseous fission product released from the vent hole.

7. The molten salt reactor according to claim 1, wherein the molten salt reactor further comprises a heat dissipating fin formed on the outer peripheral face of the reactor vessel.

8. The molten salt reactor according to claim 1, wherein the molten salt reactor further comprises a circulation device for promoting a circulating flow of the molten salt that flows from a lower part and comes out from an upper part of the molten salt flow path, and subsequently flows down in the molten salt circulation gap, and then flows into the lower part of the molten salt flow path again.

9. The molten salt reactor according to claim 1, wherein the reflector is made of graphite or SiC.

10. The molten salt reactor according to claim 1, wherein an external reflector for changing a rate of neutron leakage from inside of the reactor vessel is further provided on the outer periphery of the reactor vessel.

11. The molten salt reactor according to claim 10, wherein the external reflector is provided so as to be movable in a vertical direction.

12. The molten salt reactor according to claim 10, wherein the external reflector is supported by a coupling device that is uncoupled by power shutdown.
